(19) United States
(12) Patent Application Publication
(10) Pub. No.: US 2018/0160234 A1
(43) Pub. Date: Jun. 7, 2018

(54) A SYSTEM AND METHOD OF A CAPACITIVE MICROPHONE

(71) Applicant: WIZEDSP LTD., TIL-AVIV (IL)

(72) Inventor: OZ GABAI, TEL-AVIV (IL)

(21) Appl. No.: 15/575,363

(22) PCT Filed: May 26, 2016
(86) PCT No.: PCT/IB2016/053079

§ 371 Date: Nov. 19, 2017

Related U.S. Application Data
(60) Provisional application No. 62/167,915, filed on May 29, 2015.

(51) Int. Cl. H04R 19/04; G01H 11/06; H04R 19/00

(52) U.S. Cl. CPC H04R 19/04; H04R 2201/003; H04R 19/005; G01H 11/06

(57) ABSTRACT

A capacitive microphone including a rigid plate of a conductive material, a movable plate positioned in parallel to the rigid plate, electrically separated from the rigid plate, and held firmly with respect to the rigid plate in at least one place of the movable plate, where the movable plate and/or the rigid plate is divided into a plurality of regions according to the minimum distance between the region and the other plate, and/or the extent of motion of the region with respect to the other plate, where each of the regions includes a conductive material and the regions are separated by non-conductive materials, where each of the regions is electrically coupled to a separate connector configured for connection to a voltage source and an amplifier input, and where the voltage provided to each region is adapted to the minimum distance and/or the extent of motion for that region.

### CROSS-REFERENCE TO RELATED APPLICATIONS

This application claims the benefit of U.S. Provisional Application No. 62/167,915, filed May 29, 2015, the disclosure of which is incorporated herein by reference in its entirety.

### FIELD

The method and apparatus disclosed herein are related to the field of capacitance-based microphones, and, more particularly, but not exclusively to Micro Electronic Mechanical System microphone diaphragm.

### BACKGROUND

Cell phones, tablet computers, laptop computers, etc., use Micro Electronic Mechanical System (MEMS) microphone for their small size. A MEMS microphone is usually based on variable capacitor, in which one plate of the capacitor is elastic and can move in the presence of acoustic wave pressure, thus changing the capacity. The main challenge of MEMS microphone design is improving (e.g., increasing) the signal-to-noise ratio (SNR). One main limitation on the SNR of small-size MEMS microphones is the breakdown voltage. There is thus a widely recognized need for, and it would be highly advantageous to have, a system and method for delivering a multimedia content over a network that overcomes the above limitations.

### SUMMARY

According to one exemplary embodiment, there is provided a method, a device, and a computer program for a capacitive microphone including a rigid plate of a conductive material, a movable plate positioned in parallel to the rigid plate, electrically separated from the rigid plate, and held firmly with respect to the rigid plate in at least one place of the movable plate, where the movable plate and/or the rigid plate is divided into a plurality of regions according to the minimum distance between the region and the other plate, and/or the extent of motion of the region with respect to the other plate, where each of the regions includes a conductive material and the regions are separated with a non-conductive materials between the regions, and where each of the regions is electrically coupled to a separate connector configured for connection to at least one of: a voltage source and an amplifier input, and where voltage, provided by the voltage source to the region connected to the voltage source, is adapted to the minimum distance and/or the extent of motion.

According to another exemplary embodiment the capacitive microphone may additionally include a bias resistor electrically coupled between the connector and the voltage source, and/or a voltage divider electrically coupled between the voltage source and ground with a central tap of the voltage divider connected to the connector, and/or a summing amplifier electrically coupled to the connectors, and/or a capacitor electrically coupled between the connector and the summing amplifier, and/or a voltage source electrically coupled to at least one of the bias resistors.

According to yet another exemplary embodiment at least one of the regions may have a shape such as: radial, round, ring, quadrangle, and trapezoid.

According to still another exemplary embodiment the voltage source includes a charge pump.

Further according to yet another exemplary embodiment the capacitive microphone is a micro-electro-mechanical-system (MEMS) microphone.

Still further according to yet another exemplary embodiment the capacitive microphone may include a rigid plate of a conductive material, and a movable plate positioned in parallel to the rigid plate and held firmly with respect to the rigid plate in at least one place of the movable plate, where at least one of the movable plate and the rigid plate is divided into a plurality of regions according to at least one of: minimum distance between the region and the other plate, and extent of motion of the region with respect to the other plate, wherein each of the regions includes a conductive material and the regions are separated with a non-conductive materials between the regions, and where each of the regions is electrically coupled to a separate connector configured for connection to at least one of: a voltage source and an amplifier input.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1A is an illustration of a MEMS microphone capacitor with round plates;

FIG. 1B is an illustration of a MEMS microphone capacitor with square plates;

FIG. 1C is an illustration of a side view of a MEMS microphone capacitor with no acoustic pressure;

FIG. 1D is an illustration of a side view of a MEMS microphone capacitor under acoustic pressure;

FIG. 2 is a schematic diagram of an electric circuit of a MEMS microphone;

FIG. 3 is an illustration of a side view of a MEMS microphone under acoustic pressure showing minimal distance between plates;

FIG. 4A is an illustration of a top view of a diaphragm of a MEMS microphone;

FIG. 4B is an illustration of a side view of the MEMS microphone of 4A;

FIG. 5 is a schematic diagram of an electric circuit for a MEMS microphone with four conductive regions and four voltage sources; and

FIG. 6 is a schematic diagram of an electric circuit for a MEMS microphone with four conductive regions and a single voltage source.

### DETAILED DESCRIPTION

The invention in embodiments thereof comprises systems and methods for high-sensitivity capacitance-based microphones, and, more particularly, but not exclusively to Micro Electronic Mechanical System microphone diaphragm. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of embodiments described below is to provide at least one system and/or method for increasing the sensitivity of a MEMS microphone. However, the systems and/or methods as described herein may have other embodiments in similar technologies of capacitor-based microphones.

As described in more details below, a capacitance-based microphone, as well as in a Micro Electronic Mechanical System (MEMS) microphone, includes a rigid plate and a movable plate that together create a capacitor. The movable plate may vibrate, responsive to an acoustic wave pressure, thus changing the capacity of the microphone responsive to the acoustic signal. The MEMS microphone is usually a wide and thin cylinder and the movable plate is usually held fixed at the perimeter of the cylinder. Decreasing the thickness of the cylinder may increase the capacitance and the signal-to-noise ratio (SNR), however, decreasing the thickness of the cylinder is limited by the breakdown voltage. Similarly, increasing the voltage applied between the two plates may increase the SNR, however, increase it is also limited by the breakdown voltage.

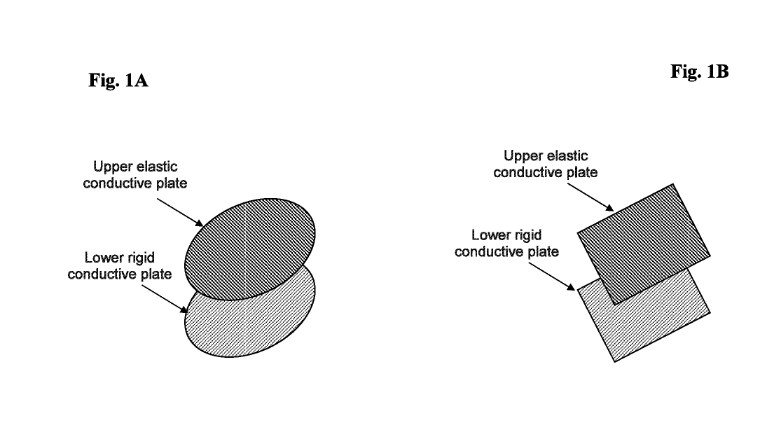

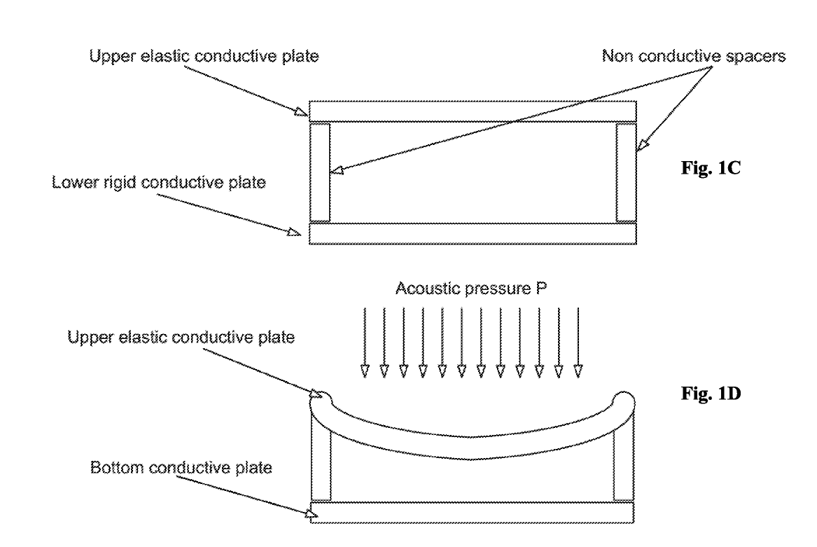

Reference is now made to FIG. 1A, which is an illustration of a MEMS microphone capacitor with round plates, according to one exemplary embodiment.

A capacitive microphone such as the MEMS microphone of FIG. 1A may include two parallel plates. One of the plates may be rigid and the other plate may be movable and/or elastic. As shown in FIG. 1A, the upper plate and the lower plate are both conductive and the upper plate is also elastic, allowing the upper plate to bend (move) when responsive to an acoustic wave.

The terms ‘upper’ and ‘lower’ or ‘bottom’ refer to the drawing, and do not imply any physical orientation of the microphone when used. In FIG. 1A the bottom plate is rigid and the upper plate is movable with respect to the bottom plate. The term ‘diaphragm’ may refer to the movable, or bendable, or elastic, or upper plate.

Reference is now made to FIG. 1B, which is an illustration of a MEMS microphone capacitor with square plates, according to one exemplary embodiment. As in FIG. 1A, the upper plate and the lower plate are both conductive and the upper plate is also elastic, allowing the upper plate to bend (move) when responsive to an acoustic wave.

Reference is now made to FIG. 1C, which is an illustration of a side view of a MEMS microphone capacitor with no acoustic pressure, according to one exemplary embodiment. The MEMS microphone capacitor of FIG. 1C may have upper and lower plates of any shape, such as, for example, the plates according to FIGS. 1A and/or 1B.

As shown in FIG. 1C, the upper and the lower plates are installed on, and or separated by, one or more non-conductive spacers.

Reference is now made to FIG. 1D, which is an illustration of a side view of a MEMS microphone capacitor under acoustic pressure, according to one exemplary embodiment.

As shown in FIG. 1D, the upper plate may bend and therefore the capacitance may change. Particularly, the upper plate may bend towards the lower plate thus increasing the capacitance. Changing the capacitance, and assuming a constant charge of the capacitor, may change the voltage over the MEMS Microphone capacitor.

Therefore, a capacitive microphone as shown in FIGS. 1A, 1B, 1C and 1D may include a rigid plate of a conductive material and a movable plate positioned in parallel to the rigid plate and held firmly with respect to the rigid plate in at least one place of the movable plate.

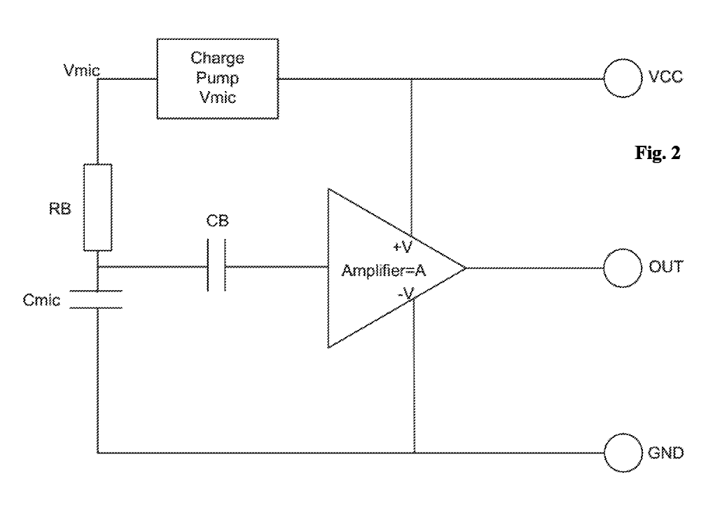

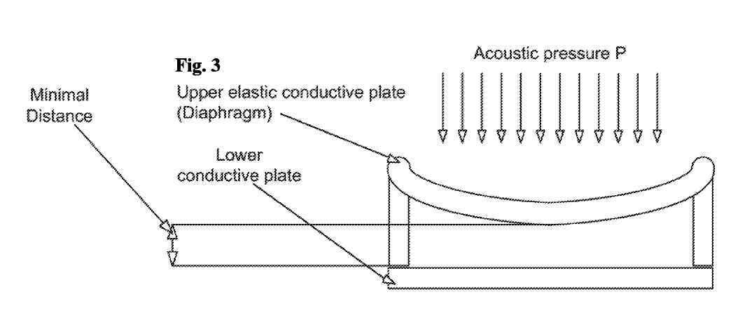

Reference is now made to FIG. 2, which is a schematic diagram of an electric circuit of a MEMS microphone, according to one exemplary embodiment.

As an option, the schematic diagram of FIG. 2 may be viewed in the context of the details of the previous Figures. Of course, however, the schematic diagram of FIG. 2 may be viewed in the context of any desired environment. Further, the aforementioned definitions may equally apply to the description below.

As shown in FIG. 2, Cmic is the MEMS microphone variable capacitor. The MEMS microphone circuit may include a MEMS microphone variable capacitor (as described with reference to FIGS. 1A-1D), a bias resistor RB, and a voltage Vmic. Vmic may be relatively high voltage, for example, in the range of 10V-50V. Vmic may be provided by a voltage source, or by a charge pump. A coupling capacitor CB may connect the variable signal of Cmic to an input of an amplifier. The value of RB is relatively high, such that RB×Cmic>>1.

After some time Cmic will be charged to Vmic and hence

Q=V_{mic}C_{mic} Eq. 1

Cmic may change its value when an acoustic wave is presented at the elastic plate of the MEMS microphone Cmic. However, the value of Q may stay relatively constant, and therefore the value of the voltage over Cmic may change, for example, according to Eq. 2:

$$Q = {V}_{mic} {C}_{mic} = ( {V}_{mic} + Δ {V}_{mic} ) ( {C}_{mic} + Δ {C}_{mic} ) ⇒ \\ Δ {V}_{mic} {C}_{mic} + Δ {C}_{mic} {V}_{mic} \approx 0 ⇒ \\ Δ {V}_{mic} = - {V}_{mic} \frac{Δ {C}_{mic}}{{C}_{mic}} \qquad Eq . 2$$

Eq. 2 shows that the sensitivity of the microphone may depend, among other parameters, on the value of Vmic. A higher Vmic may cause a higher output signal. Therefore, the highest possible voltage may be advantageous. However, the highest possible voltage may be limited by the breakdown voltage of the medium between the plates, such as air.

Reference is now made to FIG. 3, which is an illustration of a side view of a MEMS microphone under acoustic pressure showing minimal distance between plates, according to one exemplary embodiment.

As an option, the illustration of FIG. 3 may be viewed in the context of the details of the previous Figures. Of course, however, the illustration of FIG. 3 may be viewed in the context of any desired environment. Further, the aforementioned definitions may equally apply to the description below.

According to the book Modeling and Characterization of Micro electromechanical Systems, page 39, the distance where no voltage is applied, is 10 μm. Assuming deviation of maximum one third (⅓) of this gap, the minimal distance may be 7 μm. Since the breakdown voltage in air is about 3 MegaVolts/meter, the maximal voltage of Vmic may be limited to 21 Volts (omitting the normal bending due to electrical field, which is about 0.55 um, according to Modeling and Characterization of Micro electromechanical Systems page 35. The sensitivity of the MEMS microphone is therefore limited due to the limitation on Vmic.

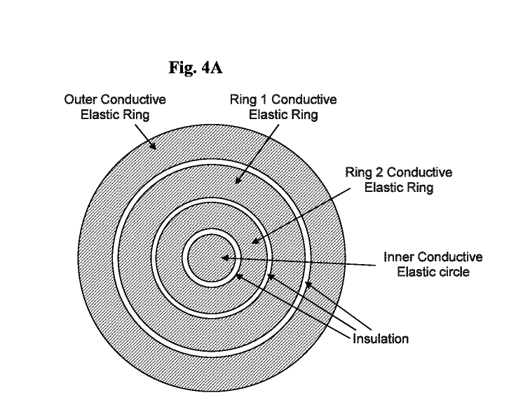

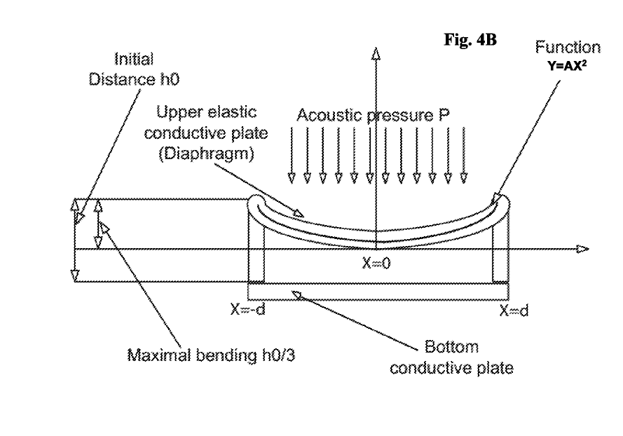

Reference is now made to FIG. 4A, which is an illustration of a top view of a diaphragm of a MEMS microphone, according to one exemplary embodiment.

As an option, the diaphragm illustration of FIG. 4A may be viewed in the context of the details of the previous Figures. Of course, however, the diaphragm illustration of FIG. 4A may be viewed in the context of any desired environment. Further, the aforementioned definitions may equally apply to the description below.

The diaphragm illustrated in FIG. 4A may be used as the upper plate, or movable plate, or elastic plate, or bending plate of FIGS. 1A-1D, FIG. 2 and FIG. 3.

As shown in FIG. 4A, the diaphragm may include two or more regions, such as a round and one or more rings. These regions may each include a conductive material, and may be separated by an insulating material. Each region may be connected to a different voltage source, or bias voltage, according to a minimal distance value, and the breakdown voltage of the medium separating the region from the bottom (rigid) plate. The medium separating the regions from the bottom (rigid) plate may typically be air.

It is appreciated that, alternatively and/or additionally, the bottom (rigid) plate may be divided into regions.

As shown in FIG. 4A, the diaphragm may include 4 conductive areas (regions) separated by insulating material. The region (e.g., the shape and/or the size) of the conductive “rings” is determined according to the equal height regions inside the MEMS microphone capacitor. For example, the width of each ring-region is determined so that the distance between the region and the bottom plate when the elastic plate is at maximum bend does not vary much across the region.

According to the acoustic wave pressure, these regions are circles. Nevertheless, different structures of the MEMS microphones may generate different shapes of conductive regions.

Reference is now made to FIG. 4B, which is an illustration of a side view of the MEMS microphone of 4A, according to one exemplary embodiment.

As an option, the illustration of FIG. 4B may be viewed in the context of the details of the previous Figures. Of course, however, the illustration of FIG. 4B may be viewed in the context of any desired environment. Further, the aforementioned definitions may equally apply to the description below.

Assuming that Eq. 3 describes the shape of the bending of the upper plate of the MEMS microphone as shown in FIG. 4B.

y=Ax² Eq. 3

One third of the initial distance h0 gives

$$A = \frac{{h}_{0}}{3 {d}^{2}} ,$$

and therefore

$$y = ( \frac{{h}_{0}}{3 {d}^{2}} ) {x}^{2} . \qquad Eq . 4$$

Therefore, the total value of Q is given by Eq. 5:

$$\begin{matrix}Q = {\int }_{x = 0}^{d} {ɛ}_{0} \frac{2 π xdx}{{h}_{0}} B ( ( \frac{{h}_{0}}{3 {d}^{2}} ) {x}^{2} + \frac{2 {h}_{0}}{3} ) = \\ = {\int }_{x = 0}^{d} {ɛ}_{0} \frac{2 π xdx}{{h}_{0}} B \frac{2 {h}_{0}}{3} + {\int }_{x = 0}^{d} {ɛ}_{0} \frac{2 π xdx}{{h}_{0}} B ( ( \frac{{h}_{0}}{3 {d}^{2}} ) {x}^{2} ) ,\end{matrix} \qquad Eq . 5$$

where the term

$${\int }_{x = 0}^{d} {ɛ}_{0} \frac{2 π xdx}{{h}_{0}} B \frac{2 {h}_{0}}{3}$$

represents the Q of normal MEMS microphone implementation, and the term

$${\int }_{x = 0}^{d} {ɛ}_{0} \frac{2 π xdx}{{h}_{0}}$$

represents the capacitance of the radial plates when no acoustic wave is presented, and where B is the breakdown voltage (B=3 Mega typically Volts/meter for air).

Therefore, the term

$${\int }_{x = 0}^{d} {ɛ}_{0} \frac{2 π xdx}{{h}_{0}} B ( ( \frac{{h}_{0}}{3 {d}^{2}} ) {x}^{2} )$$

represents the increase of Q resulting from the structure of the MEMS microphone as shown and described with reference to FIGS. 4A and 4B. According to Eq. 6,

$$Eq . 6$$

$${\int }_{x = 0}^{d} {ɛ}_{0} \frac{2 π xdx}{{h}_{0}} B ( ( \frac{{h}_{0}}{3 {d}^{2}} ) {x}^{2} ) = {ɛ}_{0} \frac{2 π }{{h}_{0}} \frac{{h}_{0}}{3 {d}^{2}} B \frac{{d}^{4}}{4} = ( B \frac{2 {h}_{0}}{3} ) ( {ɛ}_{0} \frac{π {d}^{2}}{{h}_{0}} ) ( \frac{1}{4} )$$

the theoretical increase of the Q is by 1.25

Therefore Eq. 2 may be replaced by Eq. 7:

$$Δ {V}_{mic} = - 1.25 {V}_{mic} \frac{Δ {C}_{mic}}{{C}_{mic}} , \qquad Eq . 7$$

and the increase in dB of the sensitivity may be given by Eq. 8:

20 log₁₀(1.25)=1.9382 dB Eq. 8

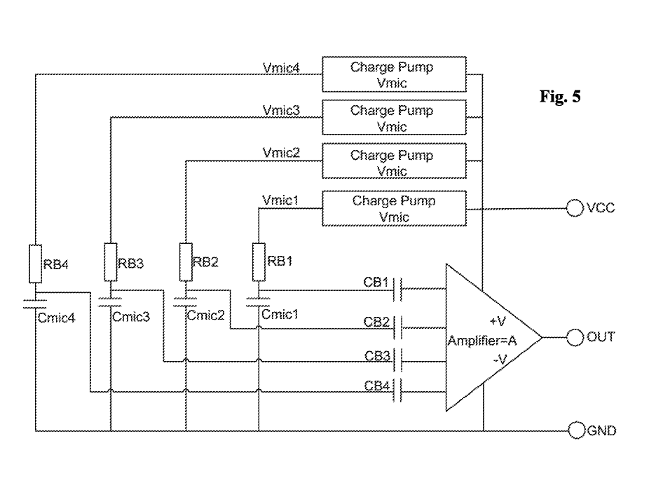

Reference is now made to FIG. 5, which is a schematic diagram of an electric circuit for a MEMS microphone with four conductive regions and four voltage sources, according to one exemplary embodiment.

As an option, the schematic diagram and/or electric circuitry of FIG. 5 may be viewed in the context of the details of the previous Figures. Of course, however, the schematic diagram and/or electric circuitry of FIG. 5 may be viewed in the context of any desired environment. Further, the aforementioned definitions may equally apply to the description below.

FIG. 5 shows a possible implementation where each capacitor conductive region may be regarded as a separate capacitor Cmic (i.e., Cmic 1, Cmic 2, Cmic 3, and Cmic 4). Each Cmic is connected on a first side to a voltage source (or a charge pump) via a bias resistor RB (i.e., RB1, RB2, RB3, and RB4, respectively), to an input of a summing amplifier via a capacitor CB (i.e., CB1, CB2, CB3, and CB4, respectively), and on the other side to ground.

Via the respective RB each Cmic receives voltage adapted to the minimum h0 distance between the conductive region and the rigid plate. The capacitors output voltages are then summed inside the amplifier. One way to sum, is to convert voltage to current and sum the currents.

It is appreciated that at least one of the movable plate and the rigid plate may be divided into a plurality of regions according to the minimum distance between the region and the other plate, and/or the extent of motion of the region with respect to the other plate. Each of the regions may include a conductive material and the regions may be separated by a non-conductive materials between the regions. Each of the regions may be electrically coupled to a separate connector connecting to a voltage source and/or an amplifier input. Each of the voltage sources may provide voltage, to the respective region, where the voltage is adapted to the minimum distance and/or the extent of motion of the respective region.

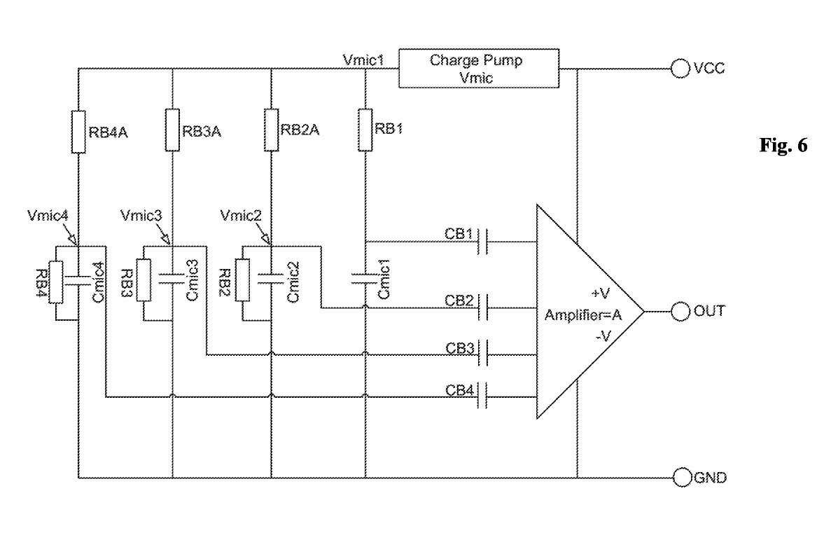

Reference is now made to FIG. 6, which is a schematic diagram of an electric circuit for a MEMS microphone with four conductive regions and a single voltage source, according to one exemplary embodiment.

As an option, the schematic diagram and/or electric circuitry of FIG. 6 may be viewed in the context of the details of the previous Figures. Of course, however, the schematic diagram and/or electric circuitry of FIG. 6 may be viewed in the context of any desired environment. Further, the aforementioned definitions may equally apply to the description below.

As shown in FIG. 6, the regions (represented by the Cmic capacitors) receive their respective required bias voltages from a single voltage source (or charge pump) via a respective resistor voltage divider. Here we may assume that Vmic1>Vmic2>Vmic3>Vmic4, as the current consumption through the resistors may be insignificant, such as in the range of less than pico Amperes, enabling the use of a single charge pump and voltage dividers.

For the second conductive area Cmic2, RB2A and RB2B may be used as a voltage divider, and Vmic1*RB2A/(RB2A+RB2B)=Vmic2. The same applies to RB3A & RB3B for the third conductive area—Cmic3, and the fourth conductive area (the inner circle of FIG. 4A or 4B) RB4A & RB4B.

It is appreciated that any of the regions may be radial, and/or round, and/or ring-shape, and/or quadrangle, and/or trapezoid, and/or any other shape.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for a capacitive microphone, the method comprising:
providing a rigid plate of a conductive material;
providing a movable plate positioned in parallel to the rigid plate, electrically separated from said rigid plate, and held firmly with respect to the rigid plate in at least one place of said movable plate;
wherein at least one of said movable plate and said rigid plate is divided into a plurality of regions according to at least one of:
minimum distance between said region and said other plate, and
extent of motion of said region with respect to said other plate;
wherein each of said regions includes a conductive material and said regions are separated with a non-conductive materials between said regions; and
wherein each of said regions is electrically coupled to a separate connector configured for connection to at least one of: a voltage source and an amplifier input; and
providing voltage, from said voltage source to said region connected to said voltage source, wherein said voltage is adapted to at least one of said minimum distance and said extent of motion.

2. The method according to claim 1 additionally comprising at least one of:
providing a bias resistor electrically coupled between said connector and said voltage source;
providing a voltage divider electrically coupled between said voltage source and ground with a central tap of said voltage divider connected to said connector;
providing a summing amplifier electrically coupled to said connectors;
providing a capacitor electrically coupled between said connector and said summing amplifier; and
providing a voltage source electrically coupled to at least one of said bias resistors.

3. The method according to claim 1, wherein at least one of said regions is at least one of: radial, round, ring-shape, quadrangle, and trapezoid.

4. The method according to claim 1, wherein said voltage source comprises a charge pump.

5. The method according to claim 1, wherein said capacitive microphone is a micro-electro-mechanical-system (MEMS) microphone.

6. A capacitive microphone comprising:
a rigid plate of a conductive material; and
a movable plate positioned in parallel to said rigid plate and held firmly with respect to said rigid plate in at least one place of said movable plate;
wherein at least one of said movable plate and said rigid plate is divided into a plurality of regions according to at least one of:
minimum distance between said region and said other plate, and
extent of motion of said region with respect to said other plate;
wherein each of said regions includes a conductive material and said regions are separated with a non-conductive materials between said regions;
wherein each of said regions is electrically coupled to a separate connector configured for connection to at least one of: a voltage source and an amplifier input.

7. The capacitive microphone according to claim 6, additionally including at least one of:
a bias resistor electrically coupled between said connector and said voltage source;
a voltage divider electrically coupled between said voltage source and ground with a central tap of said voltage divider connected to said connector;
a summing amplifier electrically coupled to said connectors;
a capacitor electrically coupled between said connector and said summing amplifier; and
a voltage source electrically coupled to at least one of said bias resistors.

8. The capacitive microphone according to claim 6, wherein said voltage sources are configured to provide voltage to said respective regions, wherein said voltage is adapted to at least one of said minimum distance and said extent of motion.

9. The capacitive microphone according to claim 6, wherein at least one of said regions is at least one of: radial, round, ring-shape, quadrangle, and trapezoid.

10. The capacitive microphone according to claim 6, wherein said voltage source comprises a charge pump.

11. The capacitive microphone according to claim 6, wherein said capacitive microphone is a micro-electro-mechanical-system (MEMS) microphone.
